(19) United States
(12) Patent Application Publication
(10) Pub. No.: US 2026/0351885 A1
(43) Pub. Date: Nov. 5, 2026

(54) CONNECTOR

(71) Applicant: SUMITOMO WIRING SYSTEMS, LTD., Mie (JP)

(72) Inventor: Shinjiro KIDA, Mie (JP)

(21) Appl. No.: 19/655,122

(22) Filed: Apr. 22, 2026

(30) Foreign Application Priority Data
May 1, 2025 (JP) 2025-075974

(51) Int. Cl. H01R 13/424; H01R 13/428; H01R 13/627; H01R 24/20; H01R 24/38; H01R 103/00

(52) U.S. Cl. CPC H01R 13/424; H01R 13/428; H01R 13/6272; H01R 24/20; H01R 24/38; H01R 2103/00

(57) ABSTRACT

A connector includes a housing and a terminal to be accommodated into the housing. The housing includes a first accommodation chamber extending in a first direction and a second accommodation chamber extending from the first accommodation chamber in a second direction intersecting the first direction. The terminal includes a first terminal portion to be accommodated into the first accommodation chamber and a second terminal portion to be accommodated into the second accommodation chamber. A locked portion is provided on a surface facing in a direction opposite to the second direction, out of an outer surface of the first terminal portion. A locking portion to be locked to the locked portion is provided on a surface facing in the second direction, out of an inner surface of the first accommodation chamber of the housing. The locking portion is visually confirmable through the second accommodation chamber.

### CROSS-REFERENCE TO RELATED APPLICATIONS

This application is based on and claims priority from Japanese Patent Application No. 2025-075974, filed on May 1, 2025, with the Japan Patent Office, the disclosure of which is incorporated herein in its entirety by reference.

### TECHNICAL FIELD

The present invention relates to a connector.

### BACKGROUND

Japanese Patent Laid-open Publication No. 2006-012498describes a coaxial plug as a terminal. The coaxial plug is L-shaped and includes a first hollow cylindrical member and a second hollow cylindrical member orthogonal to each other. A contact pin is arranged inside the first hollow cylindrical member. A core wire connection pin connectable to the contact pin is arranged inside the second hollow cylindrical member. The core wire connection pin is connected to a coaxial cable. The coaxial cable is fixed to a cable fixing bracket. The coaxial plug is accommodated in a cover. Japanese Patent Laid-open Publication No. 2023-048414 discloses a technique for connecting a first outer conductor and a second outer conductor in a proper state.

### SUMMARY

In the case of Japanese Patent Laid-open Publication No. 2006-012498, the core wire connection pin is supported on the coaxial cable extending from the cable fixing bracket, but the cover is not provided with a structure for locking the coaxial plug. Thus, the coaxial plug may rattle inside the cover.

Accordingly, the present disclosure aims to provide a connector capable of suppressing the rattling of a terminal.

The present disclosure is directed to a connector with a housing and a terminal to be accommodated into the housing, the housing including a first accommodation chamber extending in a first direction and a second accommodation chamber extending from the first accommodation chamber in a second direction intersecting the first direction, the terminal including a first terminal portion to be accommodated into the first accommodation chamber and a second terminal portion to be accommodated into the second accommodation chamber, the second terminal portion being connected to the first terminal portion, a locked portion being provided on a surface facing in a direction opposite to the second direction, out of an outer surface of the first terminal portion, a locking portion to be locked to the locked portion being provided on a surface facing in the second direction, out of an inner surface of the first accommodation chamber of the housing, and the locking portion being visually confirmable through the second accommodation chamber when the housing is a single state where the first terminal portion and the second terminal portion are not accommodated yet.

According to the present disclosure, it is possible to provide a connector capable of suppressing the rattling of a terminal.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is an exploded perspective view of a connector of one embodiment.

FIG. 2 is a perspective view of the connector of the embodiment.

FIG. 3 is a side view in section when the connector of the embodiment is connected to a mating connector.

FIG. 4 is a perspective view of a housing in the connector of the embodiment.

FIG. 5 is an enlarged front view of an essential part of the housing in the connector of the embodiment.

FIG. 6 is a longitudinal section of the housing in the connector of the embodiment.

FIG. 7 is a perspective view of a first outer conductor in the connector of the embodiment.

FIG. 8 is an enlarged front view of an essential part in a state where a first terminal portion is accommodated in a first accommodation chamber in the connector of the embodiment.

FIG. 9 is an enlarged side view in section of an essential part in the state where the first terminal portion is accommodated in the first accommodation chamber in the connector of the embodiment.

FIG. 10 is an enlarged side view in section of an essential part in a state where a second terminal portion is accommodated in a second accommodation chamber from the state of FIG. 9 in the connector of the embodiment.

### DETAILED DESCRIPTION

In the following detailed description, reference is made to the accompanying drawings, which form a part hereof. The illustrative embodiments described in the detailed description, drawings, and claims are not meant to be limiting. Other embodiments may be utilized, and other changes may be made, without departing from the spirit or scope of the subject matter presented here.

### Description of Embodiments of Present Disclosure

First, embodiments of the present disclosure are listed and described.

(1) The connector of the present disclosure is provided with a housing and a terminal to be accommodated into the housing, the housing including a first accommodation chamber extending in a first direction and a second accommodation chamber extending from the first accommodation chamber in a second direction intersecting the first direction, the terminal including a first terminal portion to be accommodated into the first accommodation chamber and a second terminal portion to be accommodated into the second accommodation chamber, the second terminal portion being connected to the first terminal portion, a locked portion being provided on a surface facing in a direction opposite to the second direction, out of an outer surface of the first terminal portion, a locking portion to be locked to the locked portion being provided on a surface facing in the second direction, out of an inner surface of the first accommodation chamber of the housing, and the locking portion being visually confirmable through the second accommodation chamber when the housing is a single state where the first terminal portion and the second terminal portion are not accommodated yet.

By locking the locking portion to the locked portion, the rattling of the first terminal portion with respect to the housing is suppressed. For example, the first terminal portion is held at a predetermined position without ratting with respect to the housing, whereby the first and second terminal portions can be properly connected.

Further, since the locking portion is visually confirmable through the second accommodation chamber, it is possible not to form an undercut in the housing when the locking portion is molded. If no undercut is formed, a mold removal hole due to the undercut is not formed in the surface of the housing, wherefore the waterproofness of the connector can be, for example, ensured.

(2) Preferably, in the connector of (1) described above, the locking portion is shaped to project in the second direction or shaped to be recessed in the second direction, and the locked portion is shaped to be recessed in the second direction or shaped to project in the second direction to be fittable to the locking portion.

Since the second terminal portion to be inserted into the second accommodation chamber can press the first terminal portion in a direction to more deeply fit the locking portion and the locked portion, the locking of the locking portion and the locked portion can be maintained.

(3) Preferably, in the connector of (2) described above, a rib extending in the first direction is provided on a surface where the locked portion is provided, the locked portion has a recess shape to cut a midway part of the rib, a groove portion extending in the first direction is provided in a surface where the locking portion is provided, the locking portion is shaped to project to fill a midway part of the groove portion, and the rib is fit into the groove portion.

By fitting the rib into the groove portion, the first terminal portion can be suppressed from rotating (inclining) in a direction intersecting the first direction with respect to the housing. Since the locked portion is provided at a midway position of the rib, the locked portion and the rib can be provided in the first terminal portion with good space efficiency. Similarly, since the locking portion is provided at a midway position of the groove portion, the locking portion and the groove portion can be provided in the housing with good space efficiency.

(4) In the connector of (3) described above, a pair of guide portions extending side by side in the first direction may be provided on the surface where the locking portion is provided, and the groove portion may be provided between the pair of guide portions.

Since the groove portion is provided between the pair of guide portions, the formation position, length and depth of the groove portion can be arbitrarily adjusted according to the arrangement and shape of each guide portion.

(5) Preferably, in the connector of any one of (1) to (4) described above, the first terminal portion is a shield terminal including a first inner conductor, a first dielectric and a first outer conductor, the first outer conductor is an electrically conductive rigid body formed by die casting or cutting, and the locked portion is fixedly provided without forming a hole in the first outer conductor.

Since a hole needs not be formed in the first outer conductor in providing the locked portion in the first outer conductor, the shielding performance of the first outer conductor can be ensured. Further, for example, the locked portion can be accurately provided in the first outer conductor by casting or cutting.

### Details of Embodiment of Present Disclosure

A specific example of the present disclosure is described below with reference to the drawings. Note that the present invention is not limited to these illustrations, but is represented by claims and intended to include all changes in the scope of claims and in the meaning and scope of equivalents.

### Embodiment

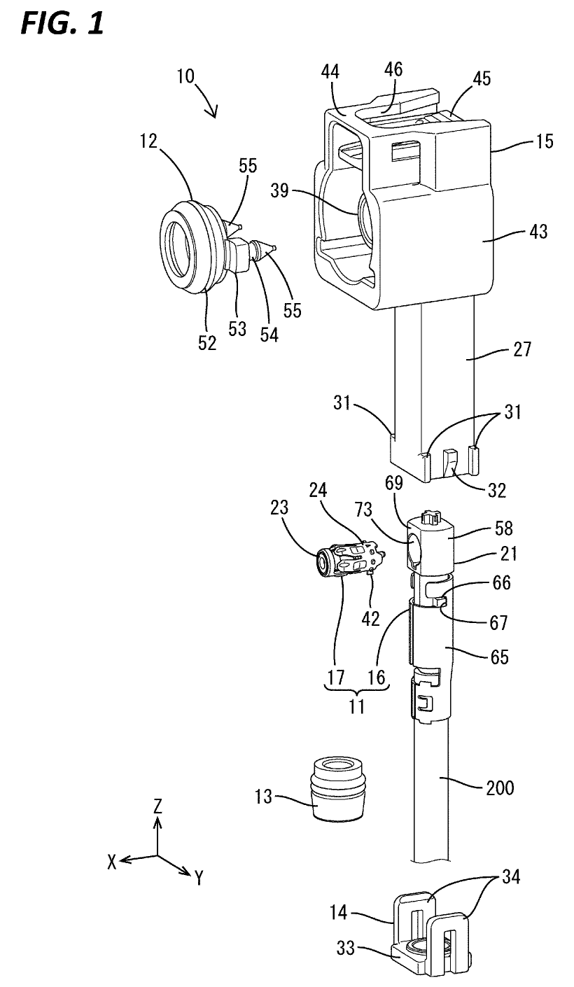

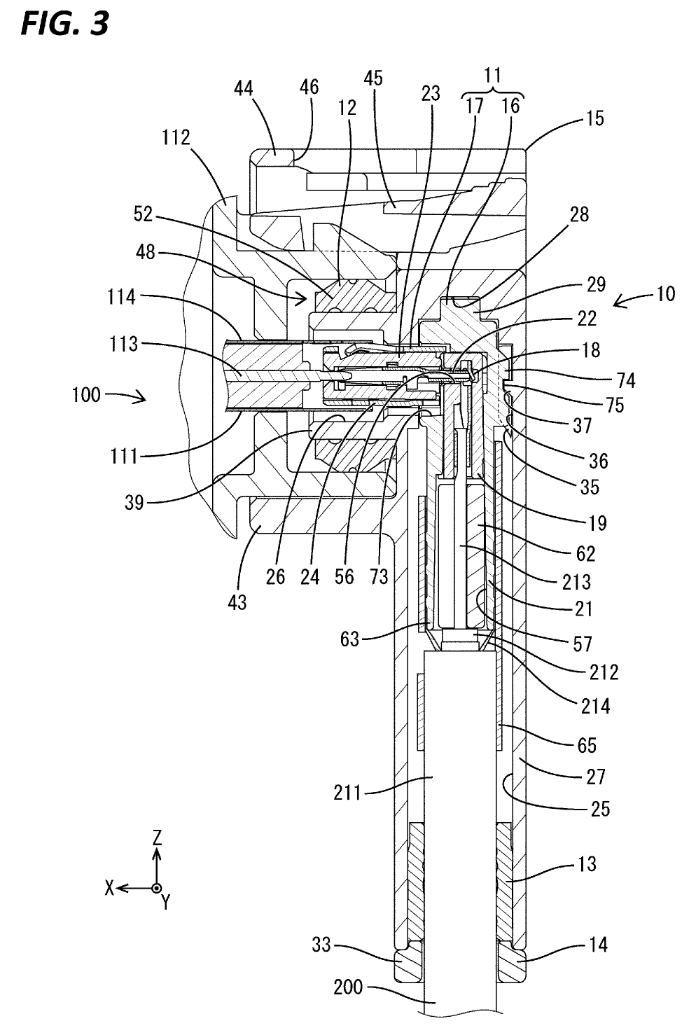

A connector 10 of one embodiment of the present disclosure is a waterproof connector and, as shown in FIG. 1, provided with a terminal 11, a sealing ring 12, a sealing plug 13, a sealing plug pressor 14 and a housing 15. As shown in FIG. 3, the housing 15 is fit to a mating connector 100. The mating connector 100 is provided with a mating housing 112 for holding a mating terminal 111. Further, the connector 10 is also a shield connector and provided on an end part of a shielded wire, which is a coaxial cable.

First, a schematic structure of the connector 10 is described.

As shown in FIG. 1, the terminal 11 is composed of a first terminal portion 16 and a second terminal portion 17 separate from each other. The first terminal portion 16 is electrically and mechanically connected to the shielded wire 200. As shown in FIG. 3, the second terminal portion 17 is electrically connected to the mating terminal 111. The first terminal portion 16 includes a first inner conductor 18, a first dielectric 19 and a first outer conductor 21. The second terminal portion 17 includes a second inner conductor 22, a second dielectric 23 and a second outer conductor 24.

The housing 15 includes a first accommodation chamber 25 and a second accommodation chamber 26 intersecting each other. The first terminal portion 16 is inserted and accommodated into the first accommodation chamber 25. After the first terminal portion 16 is accommodated into the first accommodation chamber 25, the second terminal portion 17 is inserted and accommodated into the second accommodation chamber 26. When the second terminal portion 17 is accommodated into the second accommodation chamber 26, the first outer conductor 21 contacts and is electrically connected to the second outer conductor 24. Further, when the second terminal portion 17 is accommodated into the second accommodation chamber 26, the first inner conductor 18 contacts and is electrically connected to the second inner conductor 22. Note that, in the following description of a detailed structure, a connection direction of the first terminal portion 16 to the second terminal portion 17 is a forward direction concerning a front-rear direction. The forward direction is also a fitting direction of the housing 15 to the mating connector 100. A vertical direction is based on a vertical direction of each figure. X, Y and Z in FIGS. 1-3 respectively represent the front-rear direction, a lateral direction and the vertical direction. These direction references are for convenience and do not necessarily coincide with direction references in a state where the connector 10 is installed in an unillustrated vehicle or the like.

Next, the detailed structure of the connector 10 is described.

The housing 15 is made of synthetic resin. The housing 15 is L-shaped in a side view. A part extending in the vertical direction, out of the L-shaped housing 15, is configured as a first portion 27.

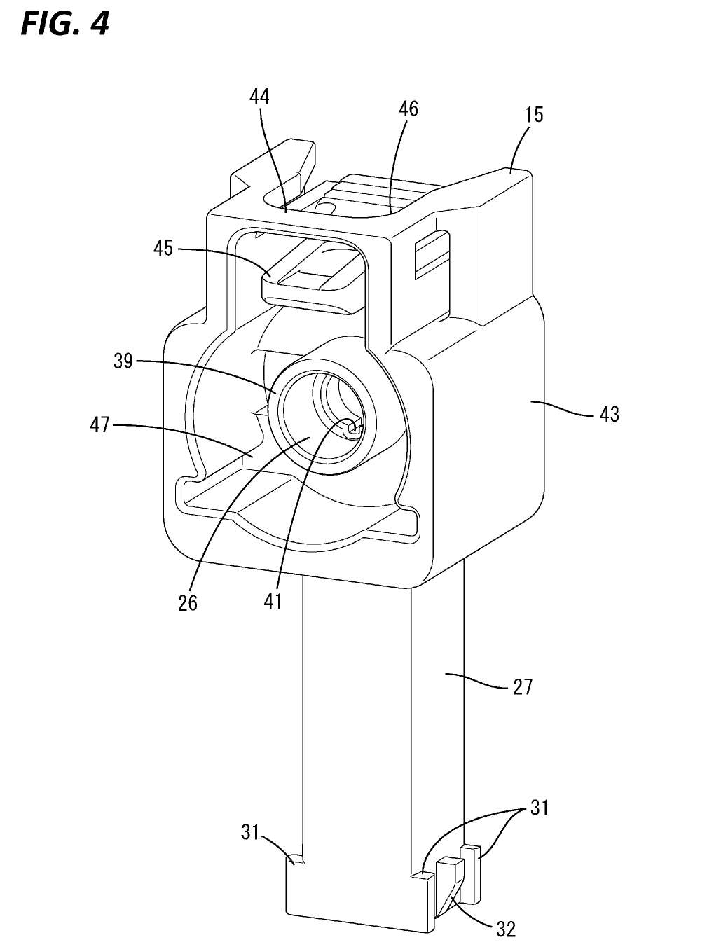

As shown in FIGS. 3 and 4, the first portion 27 is formed into a tubular shape. A transverse cross-section (cross-section along a direction orthogonal to the vertical direction) of the outer periphery of the first portion 27 is rectangular. The first accommodation chamber 25 is shaped to extend in the vertical direction inside the first portion 27. A transverse cross-section of the inner periphery of the first accommodation chamber 25 is circular. As shown in FIG. 3, the lower end of the first accommodation chamber 25 is open in the lower end surface of the first portion 27. The upper end of the first accommodation chamber 25 is closed at a position near the upper end of the first portion 27. A positioning recess 28 is provided in the inner upper surface (surface facing downward) of the upper end of the first accommodation chamber 25. A later-described positioning protrusion 29 of the first terminal portion 16 is fit into the positioning recess 28.

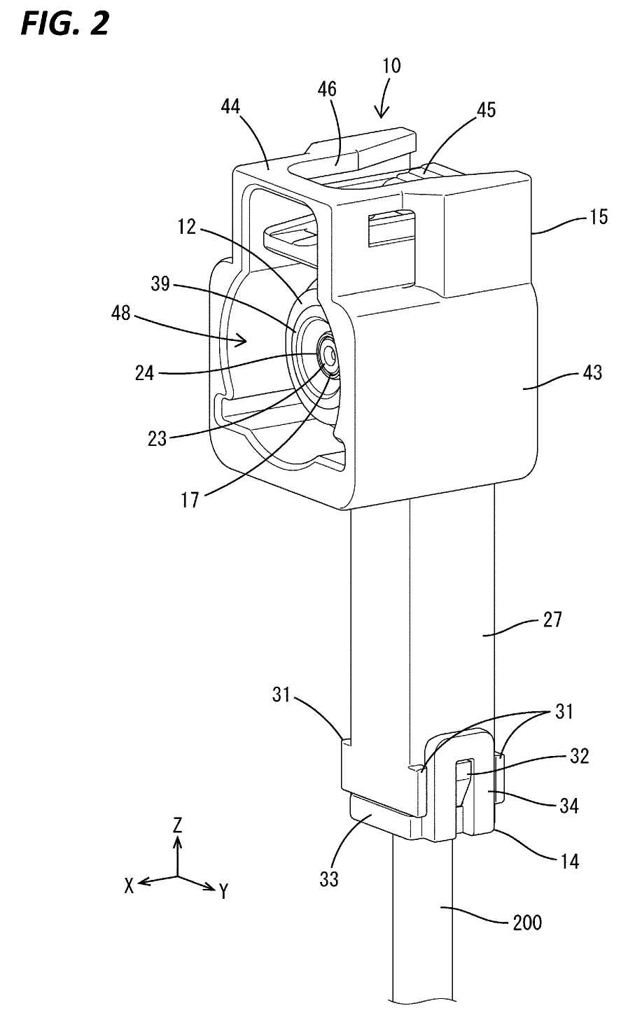

As shown in FIGS. 1 and 2, the first portion 27 includes ridge portions 31 and holding portions 32 for mounting the sealing plug presser 14. The ridge portions 31 paired in the front-rear direction are provided on outer surfaces on each of both left and right sides of a lower end part of the first portion 27. The respective ridge portions 31 extend in the vertical direction and are arranged in parallel to each other. The holding portions 32 are arranged between the front and rear ridge portions 31 in the lower end part of the first portion 27.

The sealing plug 13 is made of rubber such as silicon rubber and, as shown in FIG. 3, accommodated at a position near the lower end of the first accommodation chamber 25. The sealing plug 13 is mounted on the outer periphery of a sheath 211 of the shielded wire 200. The sealing plug 13 is sealed in a liquid-tight manner between the first portion 27 and the sheath 211.

The sealing plug presser 14 is made of synthetic resin. As shown in FIG. 1, the sealing plug presser 14 includes a pressing body 33 and locking arms 34. The pressing body 33 is shaped to correspond to the lower end part of the first portion 27. As shown in FIG. 3, the pressing body 33 partially closes an opening in the lower end of the first portion 27. The sealing plug 13 is suppressed from coming out downward from the first portion 27 by the pressing body 33. The shielded wire 200 is pulled out downward through the inside of the pressing body 33 from the first portion 27. A pair of the locking arms 34 project upward from end parts on both left and right sides of the pressing body 33. As shown in FIG. 2, the locking arm 34 is formed into a U-shaped annular shape. By fitting the holding portions 32 into the insides of the locking arms 34, the sealing plug presser 14 is locked and held on the first portion 27. The locking arms 34 are arranged between the front and rear ridge portions 31.

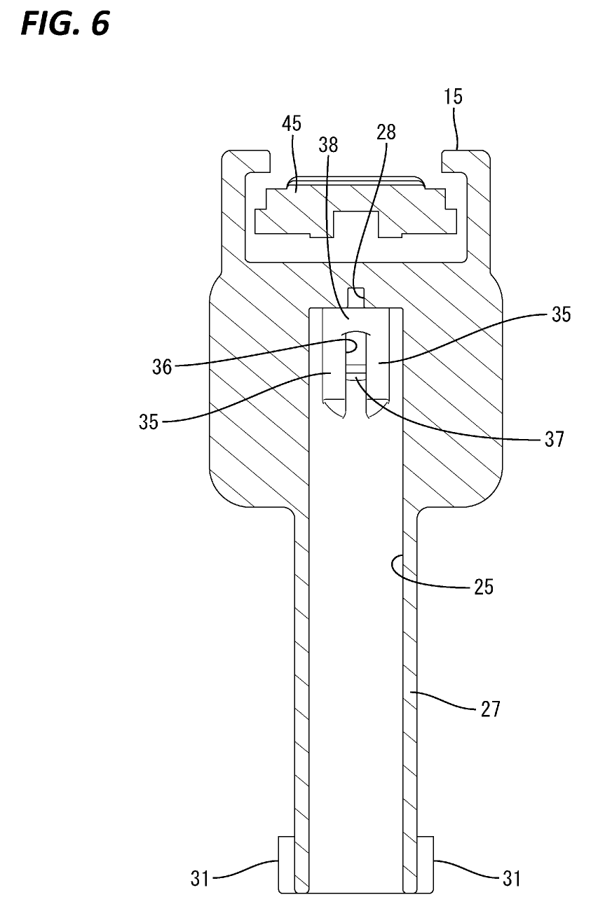

As shown in FIG. 6, the first portion 27 of the housing 15 includes guide portions 35, a groove portion 36, a locking portion 37 and a guide coupling portion 38 for mounting the first terminal portion 16.

The guide portions 35 are paired in the lateral direction and provided to project on the rear surface (surface facing forward at the rear end of the first accommodation chamber 25) of the first accommodation chamber 25 in an upper end part of the first portion 27. The respective guide portions 35 extend in the vertical direction and are arranged in parallel to each other. The lower end surface of each guide portion 35 is inclined downward toward a rear side. The front surface of each guide portion 35 is arranged along the vertical direction and the lateral direction.

The groove portion 36 is formed between the respective guide portions 35. The back surface of the groove portion 36 is also the rear surface of the first accommodation chamber 25. A groove width in the lateral direction of the groove portion 36 is constant.

The locking portion 37 projects from the rear surface of the first accommodation chamber 25. In the case of this embodiment, the locking portion 37 is provided at a midway part (intermediate part) in the vertical direction of the groove portion 36 to fill this part over the entire width in the lateral direction. As shown in FIG. 3, a projection amount of the locking portion 37 from the rear surface of the first accommodation chamber 25 is smaller than that of each guide portion 35 from the rear surface of the first accommodation chamber 25. The lower end surface of the locking portion 37 is open downward through the groove portion 36. The lower end surface of the locking portion 37 is inclined downward toward the rear side. The upper end surface of the locking portion 37 is arranged along the front-rear direction and the lateral direction. The front surface of the locking portion 37 is arranged along the vertical direction and the lateral direction. The front surface of the locking portion 37 is arranged slightly behind the front surface of each guide portion 35.

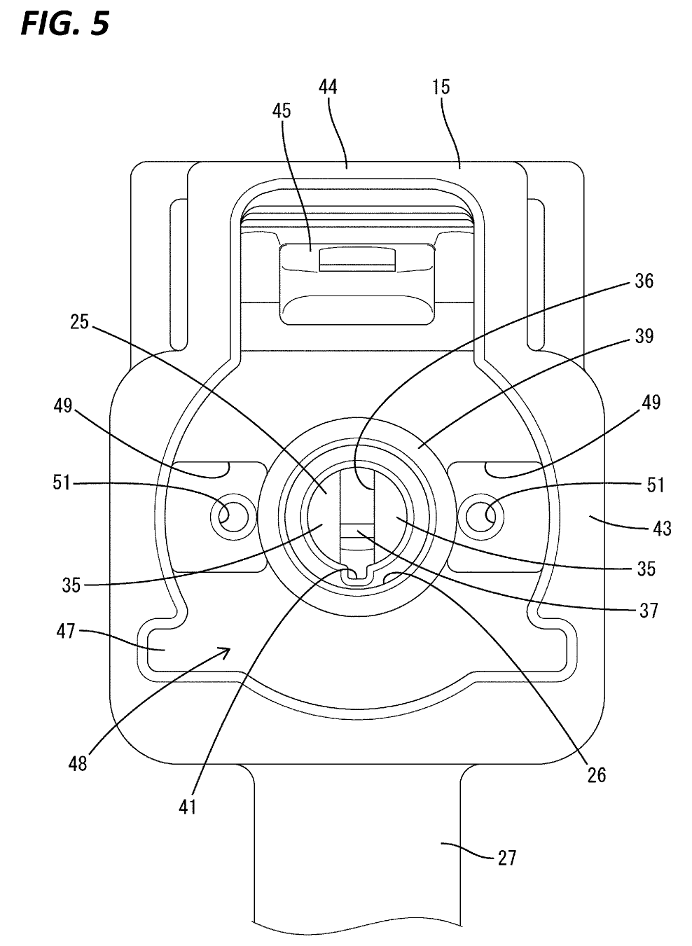

As shown in FIG. 6, the guide coupling portion 38 is shaped to extend in the lateral direction to connect upper end parts of the respective guide portions 35 on the rear surface of the first accommodation chamber 25. The upper end of the groove portion 36 is closed by the guide coupling portion 38. The lower end surface of the guide coupling portion 38 and the upper end surface of the locking portion 37 are spaced apart in the vertical direction via an upper part of the groove portion 36. The front surface of the guide coupling portion 38 is arranged along the vertical direction and the lateral direction. The front surfaces of the respective guide portions 35 and the guide coupling portion 38 are continuous without any step. The upper ends of the respective guide portions 35 and the guide coupling portion 38 are coupled to the inner upper surface of the first accommodation chamber 25. As shown in FIG. 5, the respective guide portions 35, the groove portion 36 and the locking portion 37 are visually confirmable through the second accommodation chamber 26 from the front of the housing 15 in a single state where the terminal 11 is not mounted.

The housing 15 includes a second portion 39 intersecting and integrally connected to the first portion 27. As shown in FIGS. 3-5, the second portion 39 has a tubular shape and projects forward from the upper end part of the first portion 27. A transverse cross-section (cross-section along a direction orthogonal to the front-rear direction) of the outer periphery of the second portion 39 is circular. The second accommodation chamber 26 is shaped to extend in the front-rear direction inside the second portion 39. A transverse cross-section of the inner periphery of the second accommodation chamber 26 is also circular except in a rear end part. As shown in FIG. 4, a rear end part of the inner periphery of the second accommodation chamber 26 has such a transverse cross-sectional shape in which a rectangular cut 41 is provided in a part of a circular shape having a smaller diameter than a front end part. The cut 41 is a part, through which a rotation preventing projection 42 (see FIG. 1) of the second outer conductor 24 passes.

As shown in FIG. 3, the rear end of the second accommodation chamber 26 communicates with the first accommodation chamber 25 inside the first portion 27. That is, the first and second accommodation chambers 25, 26 intersect (here, are orthogonal to) each other. In other words, the second accommodation chamber 26 is shaped to extend forward from an upper end part of the first accommodation chamber 25. A length in the front-rear direction of the second accommodation chamber 26 is shorter than a length in the vertical direction of the first accommodation chamber 25.

As shown in FIGS. 3 and 4, the housing 15 includes a fitting tube portion 43 surrounding the outer periphery of the second portion 39. The fitting tube portion 43 is provided to cover both the first portion 27 and the second portion 39. The front end of the fitting tube portion 43 is arranged forward of that of the second portion 39. The rear end of the fitting tube portion 43 is arranged at the same position in the front-rear direction as the rear surface of the first portion 27 (also the rear surface of the entire housing 15).

A bulging portion 44 gate-shaped in a front view is provided on the upper end of the fitting tube portion 43. A lock arm 45 is provided inside the bulging portion 44. The lock arm 45 is supported on left and right side walls of the bulging portion 44 and resiliently deformable in the vertical direction with those supported positions as supporting points. The upper surface of the lock arm 45 is visually confirmable from above through a window portion 46 formed in the upper wall of the bulging portion 44 except at a front end part.

As shown in FIG. 5, the housing 15 includes a coupling portion 47 coupling the fitting tube portion 43 and the second portion 39. The coupling portion 47 protrudes radially outward from the second portion 39 and is also coupled to left and right side surfaces of the first portion 27. A space between the fitting tube portion 43 and the second portion 39 and in front of the coupling portion 47 is a fitting space 48, into which the mating connector 100 is fit. As shown in FIG. 3, if the mating connector 100 is fit into the fitting space 48, the lock arm 45 locks the mating housing 112 and the housing 15 and the mating connector 100 are held in a fit state.

As shown in FIG. 5, a pair of left and right fitting recesses 49 are provided at positions on left and right sides across the second portion 39 in the front surface of the coupling portion 47. Further, the coupling portion 47 is provided with a pair of left and right through holes 51 penetrating therethrough. The front end of each through hole 51 is open in the back surface (surface facing forward) of each fitting recess 49. The sealing ring 12 is mounted into the respective fitting recesses 49 and the respective through holes 51.

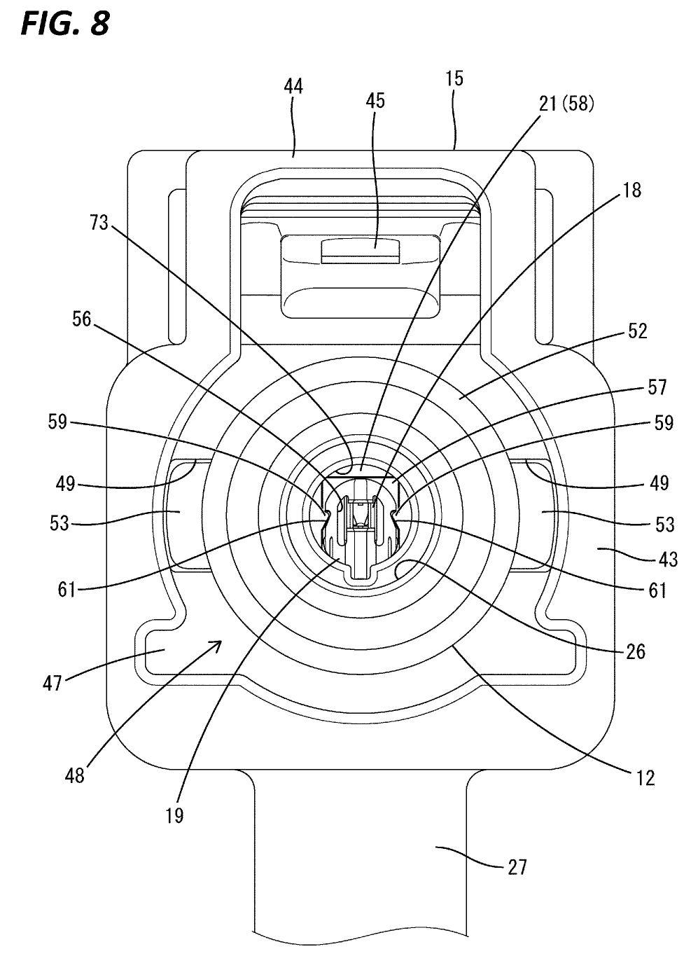

The sealing ring 12 is made of rubber such as silicon rubber. As shown in FIG. 1, the sealing ring 12 includes an annular ring body 52, a pair of left and right fitting protrusions 53 (see FIG. 8) projecting from both left and right sides of the rear end surface of the ring body 52, cylindrical inserting portions 54 projecting from the rear surfaces of the respective fitting protrusions 53 and protruding locking portions 55 protruding radially outward from rear end parts of the respective inserting portions 54. As shown in FIG. 3, the ring body 52 is mounted on the outer periphery of the second portion 39 and compressed in a radial direction between the second portion 39 and the mating housing 112. As shown in FIG. 8, each fitting protrusion 53 is fit into each fitting recess 49 from front. Although not shown, the inserting portion 54 is inserted into the through hole 51. The protruding locking portions 55 are locked to the rear surface of the coupling portion 47. In this way, the separation of the sealing ring 12 from the coupling portion 47 is suppressed.

Any of the first inner conductor 18, the first dielectric 19 and the first outer conductor 21 constituting the first terminal portion 16 is shaped to extend in the vertical direction.

The first inner conductor 18 is formed, such as by bending a plate material made of electrically conductive metal. As shown in FIG. 3, a lower end part of the first inner conductor 18 is crimped and connected to a core wire 213 exposed by removing an insulator 212 in an end part of the shielded wire 200. An upper end part of the first inner conductor 18 is open forward (hereinafter, referred to as an "open part of the first inner conductor 18"), receives the second inner conductor 22 and contacts the second inner conductor 22.

The first dielectric 19 is made of insulating resin. The first dielectric 19 has a tubular shape, is closed at a position near an upper end and is open downward. The first inner conductor 18 is inserted and accommodated into the first dielectric 19 from below. A rear end part of the second inner conductor 22 is electrically connected to the first inner conductor 18 through an opening 56 formed in an upper end part of the first dielectric 19.

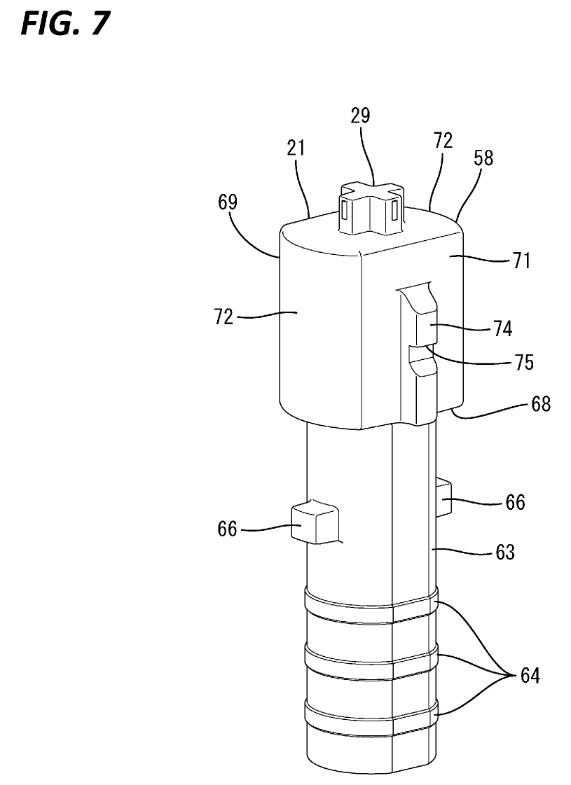

As shown in FIG. 7, the first outer conductor 21 is die-cast from electrically conductive metal and configured as a cast product. The first outer conductor 21 is formed into a tubular shape. As shown in FIG. 3, an insertion hole 57 extending in the vertical direction is provided inside the first outer conductor 21. The upper end of the insertion hole 57 is closed at a position near the upper end of the first outer conductor 21. The lower end of the insertion hole 57 is open in the lower surface of the first outer conductor 21. A transverse cross-section of the inner periphery of the insertion hole 57 is circular except at a head portion 58 to be described later. The transverse cross-section of the inner periphery of the insertion hole 57 at the head portion 58 is rectangular. As shown in FIG. 8, locking projections 59 are provided on laterally facing surfaces of the inner periphery of the insertion hole 57 at the head portion 58. The first dielectric 19 holding the first inner conductor 18 is inserted into the insertion hole 57 of the first outer conductor 21. The respective locking projections 59 lock a pair of left and right recesses 61 formed in the first dielectric 19, whereby the first dielectric 19 is held in the first outer conductor 21.

As shown in FIG. 3, out of an end part of the core wire 213 connected to the first inner conductor 18, a part extending downward from the first dielectric 19 is surrounded by a spacer 62 made of insulating resin. The end part of the core wire 213 and the first outer conductor 21 are insulated by the spacer 62.

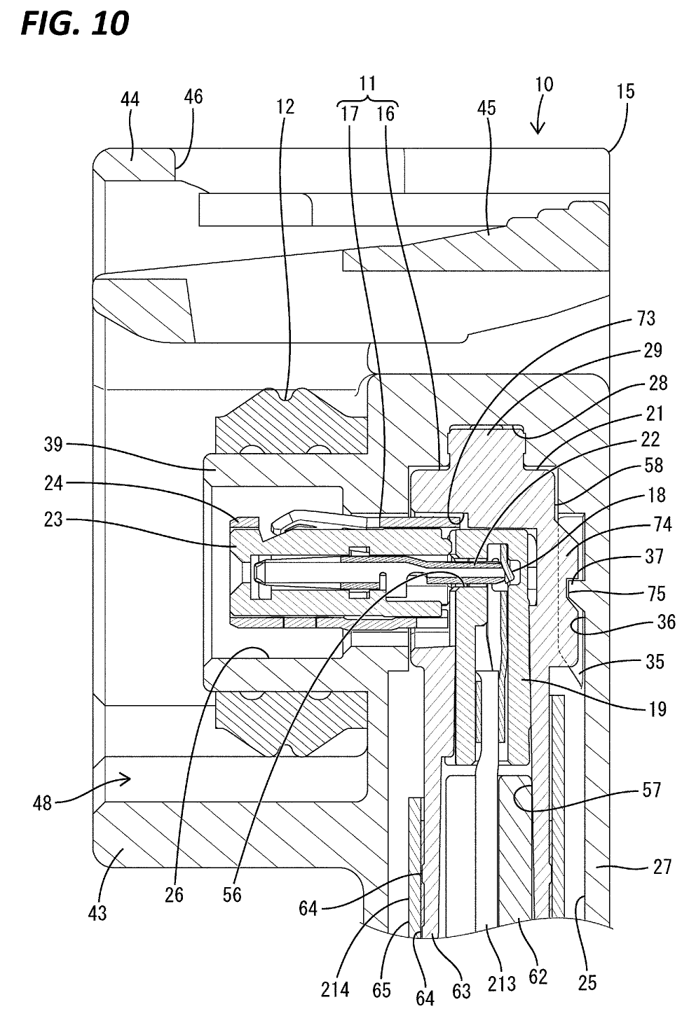

As shown in FIG. 7, the first outer conductor 21 is composed of the head portion 58 arranged in an upper end part and a trunk portion 63 extending in the vertical direction right below the head portion 58. The outer periphery of the trunk portion 63 is thinner in diameter than that of the head portion 58. A plurality of circulating ribs 64 are provided at intervals in the vertical direction on the outer periphery of the trunk portion 63. A shield portion 214 such as a braided wire exposed by removing the sheath 211 in the end part of the shielded wire 200 is put on the outer periphery of the trunk portion 63 and is fixed by the respective circulating ribs 64 when being sandwiched between a later-described crimping member 65 and the trunk portion 63 (see FIG. 10). A pair of left and right positioning portions 66 are provided on end surfaces on both left and right sides of the trunk portion 63. Each positioning portion 66 is in the form of a rectangular block and arranged above the respective circulating ribs 64. As shown in FIG. 1, the positioning portion 66 is fit into a later-described positioned portion 67 of the crimping member 65.

The crimping member 65 is formed, such as by bending a plate material made of electrically conductive metal. The crimping member 65 has a cover shape. As shown in FIG. 3, the crimping member 65 is arranged over the trunk portion 63 of the first outer conductor 21 and the sheath 211 of the shielded wire 200. The outer periphery of each of the trunk portion 63 and the sheath 211 is covered by the crimping member 65. An upper part of the crimping member 65 is crimped to the trunk portion 63 while sandwiching the shield portion 214 of the shielded wire 200. A lower part of the crimping member 65 is directly crimped to the sheath 211 of the shielded wire 200. A pair of left and right positioned portions 67 are provided in an upper end part of the crimping member 65. As shown in FIG. 1, the positioned portion 67 is open forward. By fitting each positioning portion 66 into each positioned portion 67, the misalignment of the crimping member 65 with respect to the first outer conductor 21 is suppressed.

As shown in FIG. 7, the head portion 58 is shaped to protrude further radially outward than the trunk portion 63 located below via a downward facing step surface 68. The upper surface of the head portion 58 is formed to be flat in the front-rear direction and the lateral direction. A positioning protrusion 29 cross-shaped in a plan view is provided on the upper surface of the head portion 58. By fitting the positioning protrusion 29 into the positioning recess 28, the first outer conductor 21 is positioned in the first accommodation chamber 25.

As shown in FIG. 7, the outer periphery of the head portion 58 is composed of a front surface portion 69 (see FIG. 1) facing forward, a rear surface portion 71 facing rearward and a pair of side surface portions 72 facing leftward and rightward. Each side surface portion 72 is a curved surface arcuate in a plan view. The front surface portion 69 and the rear surface portion 71 are both end surfaces along the vertical direction and the lateral direction.

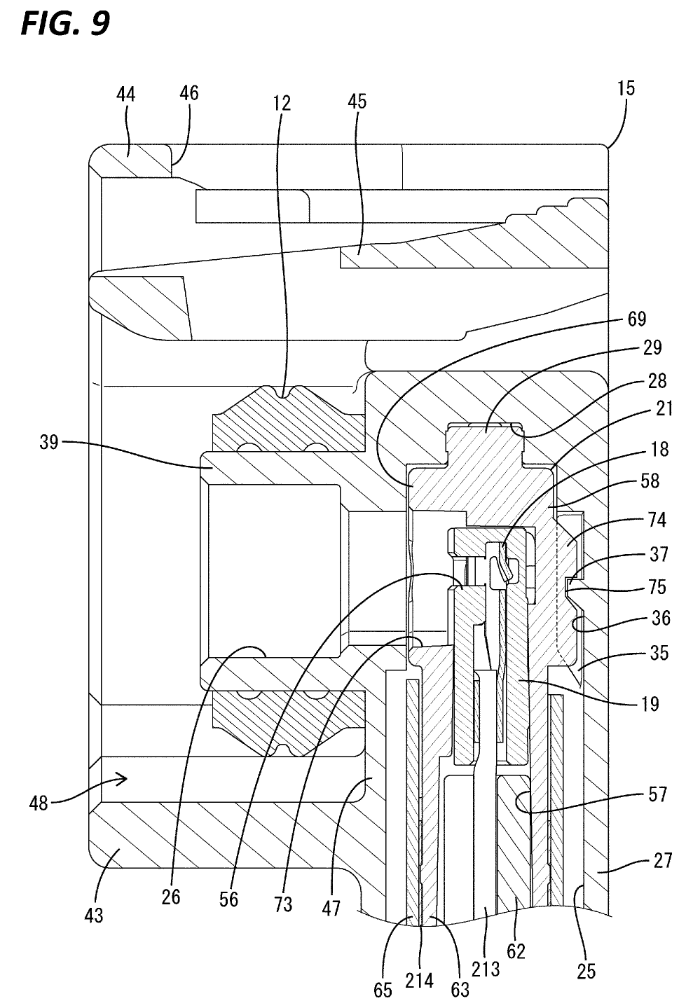

As shown in FIGS. 9 and 10, a fitting hole 73 extending in the front-rear direction is provided inside the head portion 58. A transverse cross-section of the inner periphery of the fitting hole 73 is circular except in a cut part on a lower end communicating with the cut 41 (see FIG. 8). As shown in FIG. 1, the front end of the fitting hole 73 is open in the front surface portion 69. The rear end of the fitting hole 73 communicates with an upper end part of the insertion hole 57. As shown in FIG. 10, a rear end part of the second outer conductor 24 is fit into the fitting hole 73 of the first outer conductor 21 from front.

As shown in FIG. 7, the first outer conductor 21 includes a rib 74 projecting from the rear surface portion 71 of the head portion 58. The rib 74 is shaped to extend in the vertical direction in a lateral central part of the rear surface portion 71. The rear end surface of the rib 74 is arranged along the vertical direction and the lateral direction except at a locked portion 75 to be described later. The upper end surface of the rib 74 is arranged below the upper surface of the head portion 58. The upper end surface of the rib 74 is inclined downward toward the rear side. The lower end surface of the rib 74 is arranged to be connected to the step surface 68 at the same height position. End surfaces on both left and right sides of the rib 74 are arranged along the vertical direction and the front-rear direction. A width in the lateral direction of the rib 74 is constant and slightly smaller than a groove width of the groove portion 36 formed between the respective guide portions 35 of the housing 15. As shown in FIGS. 9 and 10, the rib 74 is fit into the groove portion 36 between the respective guide portions 35.

As shown in FIG. 7, the first outer conductor 21 includes the locked portion 75 recessed by cutting a part of the rib 74. The locked portion 75 is formed by cutting a midway part (intermediate part) in the vertical direction of the rib 74 over an entire width of this part. The back surface (surface facing rearward) of the locked portion 75 is arranged along the vertical direction and the lateral direction behind the rear surface portion 71. The inner upper surface (surface facing downward) of the locked portion 75 is arranged along the front-rear direction and the lateral direction. The inner lower surface (surface facing upward) of the locked portion 75 is inclined downward toward the rear side. In short, the locked portion 75 is shaped to fit to the locking portion 37. As shown in FIGS. 9 and 10, the locking portion 37 is fit to the locked portion 75.

Any of the second inner conductor 22, the second dielectric 23 and the second outer conductor 24 constituting the second terminal portion 17 is shaped to extend in the front-rear direction.

The second inner conductor 22 is formed, such as by bending a plate material made of electrically conductive metal. The second inner conductor 22 is formed into a tubular shape. As shown in FIG. 3, a front end part of the second inner conductor 22 receives a tab-like or pin-like mating inner conductor 113 of the mating terminal 111 and electrically connected to the mating inner conductor 113. A rear end part of the second inner conductor 22 contacts the upper end part of the first inner conductor 18 and is electrically connected to the first inner conductor 18.

The second dielectric 23 is made of insulating resin. The second dielectric 23 is formed into a tubular shape extending in the front-rear direction. The second inner conductor 22 is inserted and held in the second dielectric 23. A front end part of the second inner conductor 22 is arranged inside the second dielectric 23. A rear end part of the second inner conductor 22 projects rearward from the second dielectric 23.

The second outer conductor 24 is formed, such as by bending a plate material made of electrically conductive metal. The second outer conductor 24 has a tubular shape and surrounds the outer periphery of the second dielectric 23 (see FIG. 1). As shown in FIG. 3, a front end part of the outer periphery of the second outer conductor 24 is electrically connected to the mating terminal 111 by being fit into a mating dielectric 114 of the mating terminal 111. A rear end part of the outer periphery of the second outer conductor 24 contacts the inner peripheral surface of the fitting hole 73 and is electrically connected to the first outer conductor 21.

Next, an assembly procedure and functions of the connector 10 of this embodiment are described.

First, the first inner conductor 18, the first dielectric 19, the spacer 62, the first outer conductor 21 and the crimping member 65 are assembled to confiture the first terminal portion 16 shown in FIG. 1. Here, the shielded wire 200 extends downward from the first terminal portion 16. The sealing plug 13 is mounted on the outer periphery of the shielded wire 200. Separately, the second inner conductor 22, the second dielectric 23 and the second outer conductor 24 are assembled to configure the second terminal portion 17 shown in FIG. 1. In the case of this embodiment, the sealing ring 12 is mounted in the housing 15 in advance.

The first terminal portion 16 is inserted into the first accommodation chamber 25 of the first portion 27 of the housing 15 from below. In a final stage of an insertion process of the first terminal portion 16 into the first accommodation chamber 25, the rib 74 is inserted into the groove portion 36. At this time, the end surfaces on the both left and right sides of the rib 74 contactably face the both left and right side surfaces of the groove portion 36, whereby the first terminal portion 16 is suppressed from rotating and inclining about an axis (Z axis). By further insertion of the first terminal portion 16 into the first accommodation chamber 25, the upper end surface of the rib 74 slides and rides on the lower end surface of the locking portion 37. After the resilient deformation of the rear wall part of the first portion 27, the locking portion 37 is fit (here, forcibly fit) into the locked portion 75. In this way, as shown in FIG. 9, the upper surface of the locking portion 37 contactably faces the inner upper surface of the locked portion 75 and the first terminal portion 16 is suppressed from coming out downward from the first accommodation chamber 25. Further, if the locking portion 37 is fit into the locked portion 75, the lower surface of the locking portion 37 contactably faces the inner lower surface of the locked portion 75 and the front surface of the locking portion 37 also contactably faces the back surface of the locked portion 75.

At the same time as the locking portion 37 is fit into the locked portion 75, the positioning protrusion 29 is fit into the positioning recess 28 from below. In this way, any further insertion of the first terminal portion 16 into the first accommodation chamber 25 is suppressed, and the first terminal portion 16 is accommodated and held in the first accommodation chamber 25. With the first terminal portion 16 accommodated in the first accommodation chamber 25, the opening 56 of the first dielectric 19 and the open part of the first inner conductor 18 communicating with the opening 56 are arranged to face the second accommodation chamber 26 via the fitting hole 73 as shown in FIG. 8. The sealing plug 13 is accommodated in the lower end part of the first accommodation chamber 25, and the sealing plug presser 14 is mounted in the lower end part of the first portion 27 (see FIG. 3).

From the above state, the second terminal portion 17 is inserted into the second accommodation chamber 26 from front. As shown in FIG. 10, the rear end part of the second outer conductor 24 is fit into the fitting hole 73 through the rear end part of the second accommodation chamber 26, and contacts the inner peripheral surface of the fitting hole 73. In this way, the second outer conductor 24 is electrically connected to the first outer conductor 21. The rear end part of the second inner conductor 22 contacts the upper end part of the first inner conductor 18 through the open part of the first inner conductor 18 from the opening 56 of the first dielectric 19. In this way, the second inner conductor 22 is electrically connected to the first inner conductor 18.

In the case of this embodiment, the first outer conductor 21 is arranged at a position connectable to the second outer conductor 24 in the first accommodation chamber 25 by locking the locked portion 75 by the locking portion 37. Thus, the second outer conductor 24 can be satisfactorily connected to the first outer conductor 21. Since the first inner conductor 18 is arranged inside the first outer conductor 21, the second inner conductor 22 can also be satisfactorily connected to the first inner conductor 18. Particularly, since the rib 74 is fit into the groove portion 36 and the first outer conductor 21 is suppressed from rotating and inclining about the axis in the first accommodation chamber 25, the fitting hole 73 of the first outer conductor 21 can be properly oriented to be able to receive the second outer conductor 24.

Thereafter, the connector 10 is connected to the mating connector 100. As shown in FIG. 3, the mating housing 112 is fit into the fitting space 48 of the housing 15. The mating housing 112 is locked by the lock arm 45 to suppress separation from the fitting space 48. The sealing ring 12 is compressed and held between the mating housing 112 and the second portion 39. A gap between the mating housing 112 and the housing 15 is waterproofed by the sealing ring 12. The mating outer conductor 114 enters between the second portion 39 and the second outer conductor 24 and contacts the outer peripheral surface of the second outer conductor 24. In this way, the mating outer conductor 114 is electrically connected to the second outer conductor 24. Further, the mating inner conductor 113 enters the inside of the second dielectric 23 and contacts the front end part of the second inner conductor 22. In this way, the mating inner conductor 113 is electrically connected to the second inner conductor 22.

When the mating housing 112 is fit into the fitting space 48 of the housing 15 and when the second terminal portion 17 is fit into the fitting hole 73 of the first terminal portion 16, a force for pressing the first terminal portion 16 against the rear surface of the first accommodation chamber 25 of the first portion 27 is applied to the first terminal portion 16. The locking portion 37 and the locked portion 75 are respectively provided in front of the mating housing 112 and the second terminal portion 17 in the connection direction. The locking portion 37 is shaped to project forward from the rear surface of the first accommodation chamber 25. The locked portion 75 is shaped to be recessed forward from the rear end surface of the rib 74. Thus, when the mating housing 112 and the second portion 39 are fit, the locking portion 37 and the locked portion 75 can be more deeply fit to each other.

As described above, the connector 10 of this embodiment is provided with the housing 15 and the terminal 11 to be accommodated into the housing 15. The housing 15 includes the first accommodation chamber 25 extending in the vertical direction (first direction) and the second accommodation chamber 26 extending in a forward direction (second direction) intersecting the first direction from the first accommodation chamber 25. The terminal 11 includes the first terminal portion 16 to be accommodated into the first accommodation chamber 25 and the second terminal portion 17 to be accommodated into the second accommodation chamber 26. The second terminal portion 17 is connected to the first terminal portion 16. The locked portion 75 is provided on the surface facing rearward (in a direction opposite to the second direction), out of the outer surface of the first terminal portion 16. The locking portion 37 to be locked to the locked portion 75 is provided on the surface facing forward (in the second direction), out of the inner surface of the first accommodation chamber 25 of the housing 15. In a single state of the housing 15 where the first and second terminal portions 16, 17 are not accommodated yet, the locking portion 37 is visually confirmable through the second accommodation chamber 26.

By locking the locking portion 37 to the locked portion 75, the rattling of the first terminal portion 16 with respect to the housing 15 is suppressed. For example, the first terminal portion 16 is held at a predetermined position without rattling with respect to the housing 15, whereby the first and second terminal portions 16, 17 can be properly connected. Further, since the locking portion 37 is visually confirmable through the second accommodation chamber 26, a complicated sliding mold structure is unnecessary when the locking portion 37 is molded, and it is possible not to form an undercut in the housing 15. If no undercut is formed, a mold removal opening caused by the undercut is not formed in the surface of the housing 15, wherefore the waterproofness of the connector 10 can be ensured.

The locking portion 37 is shaped to project forward (in the second direction) in the housing 15. The locked portion 75 is shaped to be recessed forward (in the second direction) to be fittable to the locking portion 37 in the first terminal portion 16. Thus, the second terminal portion 17 to be inserted into the second accommodation chamber 26 can press the first terminal portion 16 in a direction to more deeply fit the locking portion 37 and the locked portion 75 (pressing from front from a fitting side), and the locking of the locking portion 37 and the locked portion 75 can be maintained.

The rib 74 extending in the vertical direction (first direction) is provided on the surface where the locked portion 75 is provided. The locked portion 75 has a recess shape to cut the midway part of the rib 74. The groove portion 36 extending in the vertical direction (first direction) is provided on the surface where the locking portion 37 is provided. The locking portion 37 is shaped to project to fill a midway part of the groove portion 36. The rib 74 is fit into the groove portion 36.

The rib 74 is fit into the groove portion 36, whereby the first terminal portion 16 can be suppressed from rotating (inclining) in a direction intersecting the vertical direction (first direction) with respect to the housing 15. Since the locked portion 75 is provided at a midway position of the rib 74, the locked portion 75 and the rib 74 can be provided in the first terminal portion 16 with good space efficiency. Similarly, since the locking portion 37 is provided at a midway position of the groove portion 36, the locking portion 37 and the groove portion 36 can be provided in the housing 15 with good space efficiency.

The pair of guide portions 35 extending side by side in the vertical direction (first direction) are provided on the surface where the locking portion 37 of the housing 15 is provided. The groove portion 36 is provided between the pair of guide portions 35. According to this, the formation position, length and depth of the groove portion 36 can be arbitrarily adjusted according to the arrangement and shape of each guide portion 35.

The first terminal portion 16 is a shield terminal including the first inner conductor 18, the first dielectric 19 and the first outer conductor 21. The first outer conductor 21 is an electrically conductive rigid body formed by die casting, and the locked portion 75 is fixedly provided without forming a hole in the first outer conductor 21. Since a hole needs not be formed in the first outer conductor 21 in providing the locked portion 75 in the first outer conductor 21, the shielding performance of the first outer conductor 21 can be ensured. Particularly, in the case of this embodiment, the locked portion 75 can be accurately provided in the first outer conductor 21 by casting without performing bending or the like by a press.

### Other Embodiments of Disclosure

The above embodiment disclosed this time should be considered illustrative in all aspects, rather than restrictive.

In the case of the above embodiment, the first outer conductor is a cast product formed by die casting. In contrast, according to another embodiment, a first outer conductor may be a cut product formed by cutting.

In the case of the above embodiment, the locking portion is shaped to project forward (in the second direction) in the housing, and the locked portion is shaped to be recessed forward (in the second direction) in the first terminal portion. In contrast, according to another embodiment, a locking portion may be shaped to be recessed forward (in the second direction) in a housing and a locked portion may be shaped to project forward (in the second direction) in a first terminal portion, contrary to the above embodiment.

In the case of the above embodiment, the connector is a waterproof connector including the sealing ring, the sealing plug and the like. In contrast, according to another embodiment, a connector may be a non-waterproof connector not including a sealing ring, a sealing plug and the like.

In the case of the above embodiment, the wire to be connected to the first terminal portion is the shielded wire including the shield portion. In contrast, according to another embodiment, a wire to be connected to a first terminal portion may be a normal coated wire or the like not including a shield portion. If the wire does not include the shield portion, a first outer conductor and a first dielectric can be omitted from the first terminal portion and a second outer conductor and a second dielectric can be omitted from a second terminal portion.

From the foregoing, it will be appreciated that various exemplary embodiments of the present disclosure have been described herein for purposes of illustration, and that various modifications may be made without departing from the scope and spirit of the present disclosure. Accordingly, the various exemplary embodiments disclosed herein are not intended to be limiting, with the true scope and spirit being indicated by the following claims.

What is claimed is:

1. A connector, comprising a housing and a terminal to be accommodated into the housing,
the housing including a first accommodation chamber extending in a first direction and a second accommodation chamber extending from the first accommodation chamber in a second direction intersecting the first direction,
the terminal including a first terminal portion to be accommodated into the first accommodation chamber and a second terminal portion to be accommodated into the second accommodation chamber,
the second terminal portion being connected to the first terminal portion,
a locked portion being provided on a surface facing in a direction opposite to the second direction, out of an outer surface of the first terminal portion,
a locking portion to be locked to the locked portion being provided on a surface facing in the second direction, out of an inner surface of the first accommodation chamber of the housing, and
the locking portion being visually confirmable through the second accommodation chamber when the housing is a single state where the first terminal portion and the second terminal portion are not accommodated yet.

2. The connector of claim 1, wherein:
the locking portion is shaped to project in the second direction or shaped to be recessed in the second direction, and
the locked portion is shaped to be recessed in the second direction or shaped to project in the second direction to be fittable to the locking portion.

3. The connector of claim 2, wherein:
a rib extending in the first direction is provided on a surface where the locked portion is provided,
the locked portion has a recess shape to cut a midway part of the rib,
a groove portion extending in the first direction is provided in a surface where the locking portion is provided,
the locking portion is shaped to project to fill a midway part of the groove portion, and
the rib is fit into the groove portion.

4. The connector of claim 3, wherein:
a pair of guide portions extending side by side in the first direction are provided on the surface where the locking portion is provided, and
the groove portion is provided between the pair of guide portions.

5. The connector of claim 1, wherein:
the first terminal portion is a shield terminal including a first inner conductor, a first dielectric and a first outer conductor,
the first outer conductor is an electrically conductive rigid body formed by die casting or cutting, and
the locked portion is fixedly provided without forming a hole in the first outer conductor.
